(19) United States
(12) Patent Application Publication
(10) Pub. No.: US 2023/0236909 A1
(43) Pub. Date: Jul. 27, 2023

(54) SERVICE MESH ARCHITECTURE FOR INTEGRATION WITH ACCELERATOR SYSTEMS

(71) Applicants: Kefei Zhang, Shanghai (CN); Cunming Liang, Shanghai (CN); Ping Yu, Shanghai (CN); Qiming Liu, Jiangsu Province (CN); Xingping Ruan, Shanghai 31 (CN); Haiyue Wang, Shanghai 31 (CN); Xiang Dai, Shnaghai (CN)

(72) Inventors: Kefei Zhang, Shanghai (CN); Cunming Liang, Shanghai (CN); Ping Yu, Shanghai (CN); Qiming Liu, Jiangsu Province (CN); Xingping Ruan, Shanghai 31 (CN); Haiyue Wang, Shanghai 31 (CN); Xiang Dai, Shnaghai (CN)

(21) Appl. No.: 18/127,960

(22) Filed: Mar. 29, 2023

(30) Foreign Application Priority Data
Dec. 20, 2022 (WO) PCT/CN2022/140256

(51) Int. Cl. G06F 9/54; G06F 13/16

(52) U.S. Cl. CPC G06F 9/545; G06F 13/1663; G06F 2213/0026; G06F 2213/0038

(57) ABSTRACT

A processing apparatus can include a memory device having a user space for executing user applications. The processing apparatus can further include infrastructure communication circuitry that can receive a request from a user application executing in the user space. The infrastructure communication circuitry can perform a service mesh operation, in response to the request, without a sidecar proxy. Other systems and methods are described.

This application claims the benefit of priority to International Application No. PCT/CN2022/140256, filed Dec. 20, 2022, which is incorporated herein by reference in its entirety.

### BACKGROUND

Distributed computing systems are computing environments in which various components are spread across multiple computing devices on a network. Edge computing has its origins in distributed computing. At a general level, edge computing refers to the transition of compute and storage resources closer to endpoint devices (e.g., consumer computing devices, user equipment, etc.) in order to optimize total cost of ownership, reduce application latency, improve service capabilities, and improve compliance with security or data privacy requirements. Edge computing may, in some scenarios, provide a cloud-like distributed service that offers orchestration and management for applications among many types of storage and compute resources. As a result, some implementations of edge computing have been referred to as the “edge cloud” or the “fog”, as powerful computing resources previously available only in large remote data centers are moved closer to endpoints and made available for use by consumers at the “edge” of the network.

Distributed and edge computing systems can make use of a microservice architecture. At a general level, a microservice architecture enables rapid, frequent and reliable delivery of complex applications. However, latencies can be introduced due to increased networking needs of the microservice architecture.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an overview of an edge cloud configuration for edge computing.

FIG. 2 illustrates operational layers among endpoints, an edge cloud, and cloud computing environments.

FIG. 3 illustrates an example approach for networking and services in an edge computing system.

FIG. 4 illustrates deployment of a virtual edge configuration in an edge computing system operated among multiple edge nodes and multiple tenants.

FIG. 5 illustrates a processing apparatus architecture in which some example embodiments can be implemented.

FIG. 6 illustrates dSyscall workflow in accordance with some embodiments.

FIG. 7 illustrates distributed system framework components according to some example embodiments.

FIG. 8 illustrates components of an offloaded transport and host library according to some embodiments.

FIG. 9A illustrates an overview of different data paths organized into a flexible system having IPU/DPU elements according to example embodiments.

FIG. 9B illustrates an overview of different data paths organized into a flexible system having IPU/DPU elements according to example embodiments.

FIG. 10A provides an overview of example components for compute deployed at a compute node in an edge computing system.

FIG. 10B provides a further overview of example components within a computing device in an edge computing system.

### DETAILED DESCRIPTION

Distributed computing systems and cloud computing systems can be built around a microservice architecture. A microservice architecture can be designed based on lifecycle, networking performance requirements and needs, system state, binding, and other aspects of the corresponding distributed system, and can include arranging a software application as a collection of services that communicate through protocols. A service mesh can serve as an abstraction layer of communication between services by controlling how different parts of an application share data with one another. This can be done using an out-of-process model such as a sidecar. In the context of systems described herein, a sidecar can serve as a proxy instance for each service instance of a service (e.g., microservice) to be provided.

Service meshes, sidecars, or proxies may decouple service logic from communication elements. The service mesh is extended so that the service is aware of service chunks and the service internal communications among the service chunks, wherein a service chunk can be understood to include one or more microservices or service components for a service being consumed over a certain period of time during a service session. The extended sidecars/library proxies decouple service chunks from mechanisms for dealing with remote service chunks making it appear to each service chunk that its sibling service chunks are local. When a service roaming decision is made, inter-chunk affinity plays a role. The extended mesh collects and processes telemetry to maximize grouping of service chunks during service roaming. In the case that a service chunk is migrated to a remote location from another peer service chunk, the sidecar transforms the gateway to that peer service chunk to a network address instead of a localhost IP address.

The extended sidecars/library proxies are guided by a service—service chunk association and translate inter-service communications to perform the service chunk—service chunk routing of traffic within the sidecar logic so that roaming does not introduce extra routing at both the service-to-service level and then within the service itself. In particular, the extended sidecars implement efficient broadcast/multicast schemes automatically (as guided by main logic pf a service).

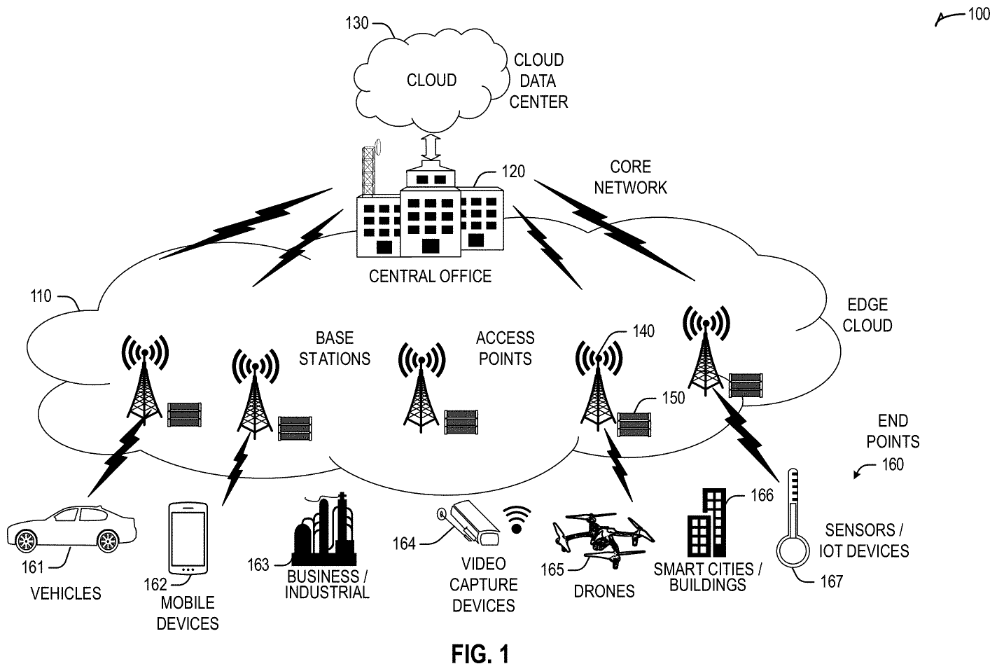

However, sidecars and proxies can introduce latency to a system due to the network connections to data paths provided in implementations of sidecars and proxies. Systems and methods according to embodiments provide an architecture including hardware and software components to address high latency and reduced efficiencies issues introduced in microservice infrastructure. Some systems and methods in which example embodiments can be implemented are described with respect to FIG. 1-4.

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

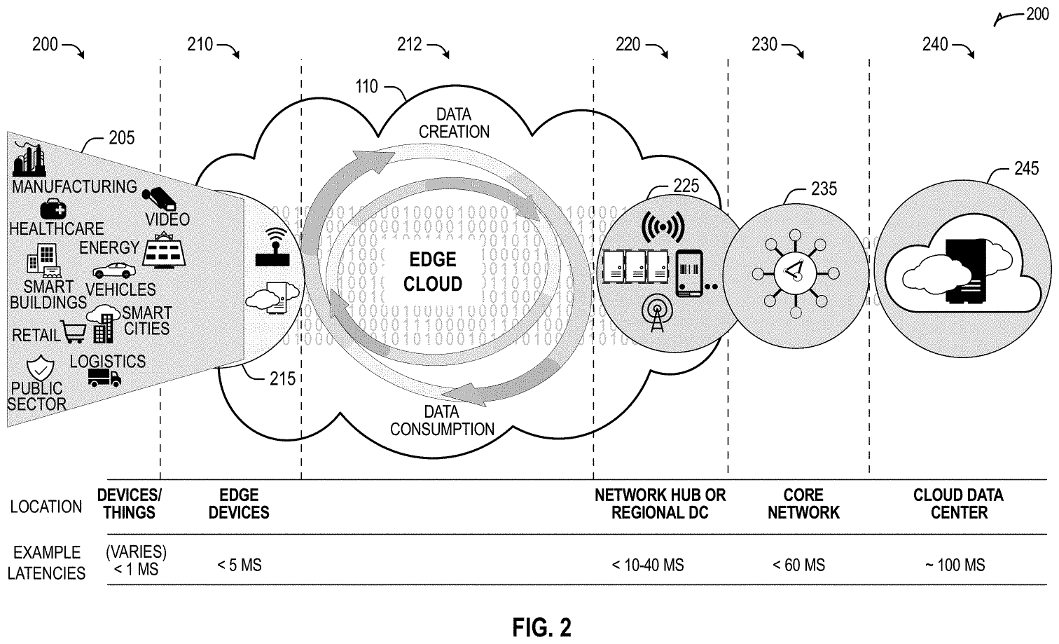

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

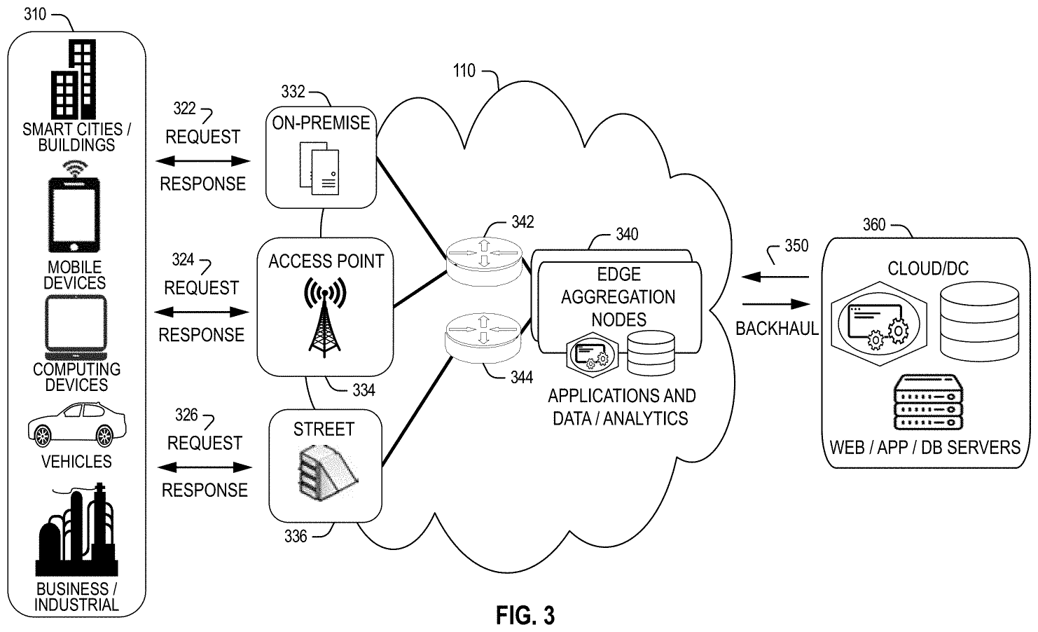

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premises network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

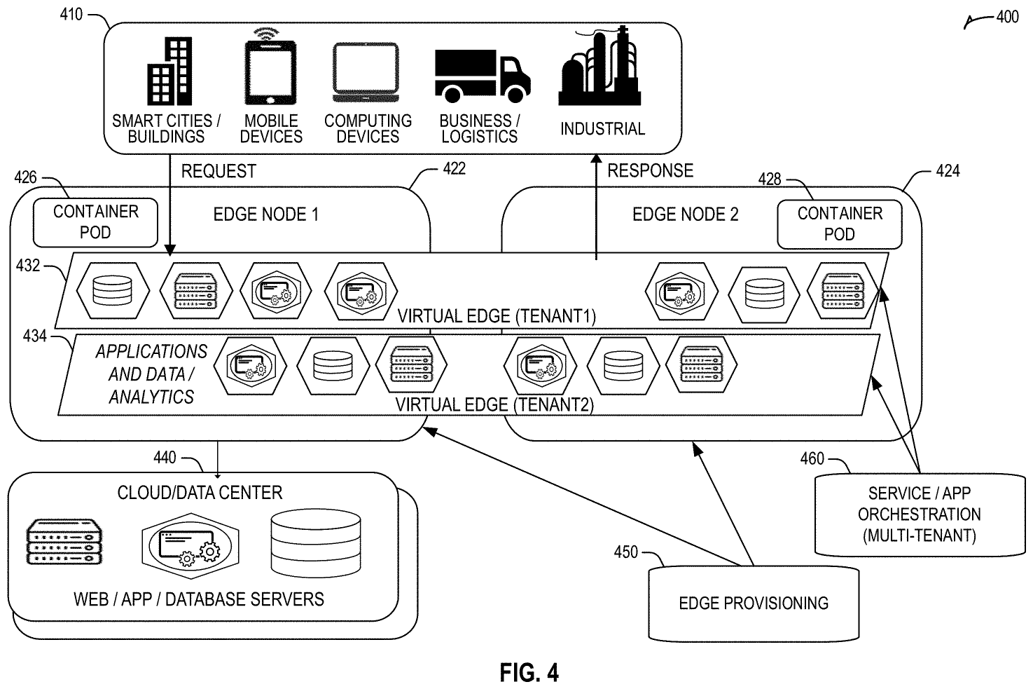

FIG. 4 illustrates deployment and orchestration for virtual edge configurations across an edge computing system operated among multiple edge nodes and multiple tenants. Specifically, FIG. 4 depicts coordination of a first edge node 422 and a second edge node 424 in an edge computing system 400, to fulfill requests and responses for various client endpoints 410 (e.g., smart cities/building systems, mobile devices, computing devices, business/logistics systems, industrial systems, etc.), which access various virtual edge instances. Here, the virtual edge instances 432, 434 provide edge compute capabilities and processing in an edge cloud, with access to a cloud/data center 440 for higher-latency requests for websites, applications, database servers, etc. However, the edge cloud enables coordination of processing among multiple edge nodes for multiple tenants or entities.

In the example of FIG. 4, these virtual edge instances include: a first virtual edge 432, offered to a first tenant (Tenant 1), which offers a first combination of edge storage, computing, and services; and a second virtual edge 434, offering a second combination of edge storage, computing, and services. The virtual edge instances 432, 434 are distributed among the edge nodes 422, 424, and may include scenarios in which a request and response are fulfilled from the same or different edge nodes. The configuration of the edge nodes 422, 424 to operate in a distributed yet coordinated fashion occurs based on edge provisioning functions 450. The functionality of the edge nodes 422, 424 to provide coordinated operation for applications and services, among multiple tenants, occurs based on orchestration functions 460.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS engines, Servlets, servers, or other computation abstraction may be partitioned according to a DICE layering and fan-out structure to support a RoT context for each. Accordingly, the respective RoTs spanning devices 410, 422, and 440 may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or respective computing systems and resources which are co-owned or co-managed by multiple owners).

For instance, each edge node 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices 432, 434 are partitioned according to the needs of each container.

To reduce overhead that can be introduced in any of the systems described with reference to FIG. 1-4, some systems and operators have introduced optimization methodologies. For example, some systems implement an extended Berkeley packet filter (eBPF), which can help cut through the network traffic from full ethernet to the socket layer. eBPF can be understood as a sidecar-less service mesh that offloads a service (e.g., a microservice or any other service) from a sidecar process to the kernel. However, due to constraints present in the operation of eBPF, some types of service mesh logic cannot be offloaded to the kernel, limiting the usability and interoperability of eBPF.

### Sidecar-Less Service Mesh Architecture

Embodiments address these and other concerns by reserving some certain dedicated hardware resources and defining a platform level framework running with more privilege than the user space software to fulfill service mesh functionalities. This low-level framework provides a set of distributed system function calls (dSyscalls), which applications can use in a manner similar to syscalls (wherein a “syscall” can be defined as, e.g., a programmatic method by which a computer program requests a service from the kernel) and can integrate with various accelerators (e.g., infrastructure processing units (IPUs) and data processing units (DPUs) to provide a hardware enhanced, reliable transport for service mesh.

Some accelerators that can be integrated according to example embodiments can include Intel® QuickAssist Technology (QAT), IAX or Intel® Data Streaming Accelerator (DSA). Other accelerators can include Cryptographic CoProcessor (CCP) or other accelerators available from Advanced Micro Devices, Inc. (AMD®) of Sunnyvale, Calif. Still further accelerators can include an ARM®-based accelerators available ARM Holdings, Ltd. or a customer thereof, or their licensees or adopters, such as Security Algorithm Accelerators and CryptoCell-300 Family accelerators. Further accelerators can include AI Cloud Accelerator (QAIC) available from Qualcomm® Technologies, Inc. Cryptographic accelerators can include look-aside engines to offload the Host processor to improve the speed of Internet Protocol security (IPsec) encapsulating security payload (ESP) operations and similar operations to reduce power in cost-sensitive networking products.

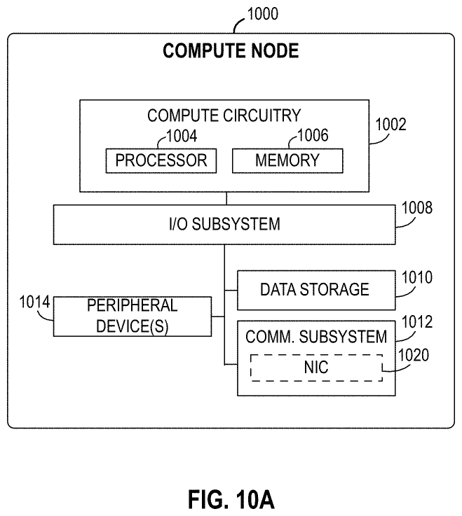

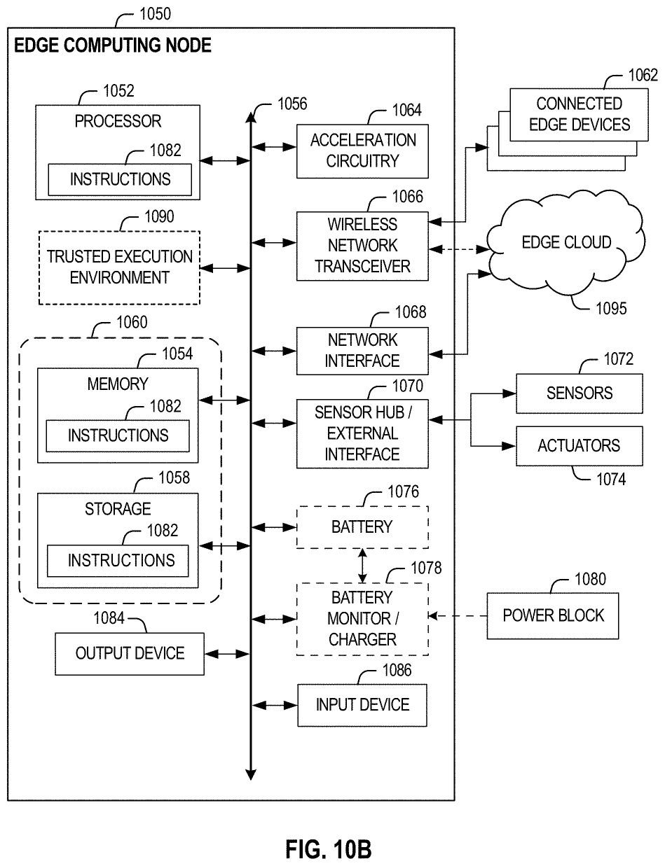

In embodiments, the service mesh can be deployed across sockets (e.g., x86 sockets), wherein the sockets are connected to IPU/DPU through links (e.g., the interconnect 1056 (FIG. 10B), which may include any number of technologies, including industry standard architecture (ISA), extended ISA (EISA), peripheral component interconnect (PCI), peripheral component interconnect extended (PCIx), PCI express (PCIe) as described below with reference to FIG. 10B).

In examples, the IPU/DPUs can connect to each other through ethernet switches. Instead of sending ethernet packets from host ethernet controllers, software on x86 sockets can sends out scatter-gather buffers of layer 4 payloads through customized PCIe transport. L4 payloads are transported between CPU and IPU/DPU through PCIe links. In example embodiments of the disclosure, although host memory and IPU/DPU memory are located independently, an efficient memory shadowing mechanism is provided within PCIe, compute express link (CXL), etc., and corresponding software and protocols. Accordingly, the requests and responses of software applications or other user applications do not need to be capsulated into an ethernet frame. Instead, requests and responses are delivered by the memory shadowing mechanism including in the system of example embodiments.

In some available service mesh architectures, a data path can include, as a first overhead, the socket connections between application containers and sidecars or proxies. A second source or cause of overhead can include sidecars or proxy execution performance. In addition, a connection must be provided between sidecars. In contrast, architectures according to example embodiments can execute without at least the first overhead, and additionally reduce or eliminate the second source of overhead and reduce or eliminate connections between sidecars.

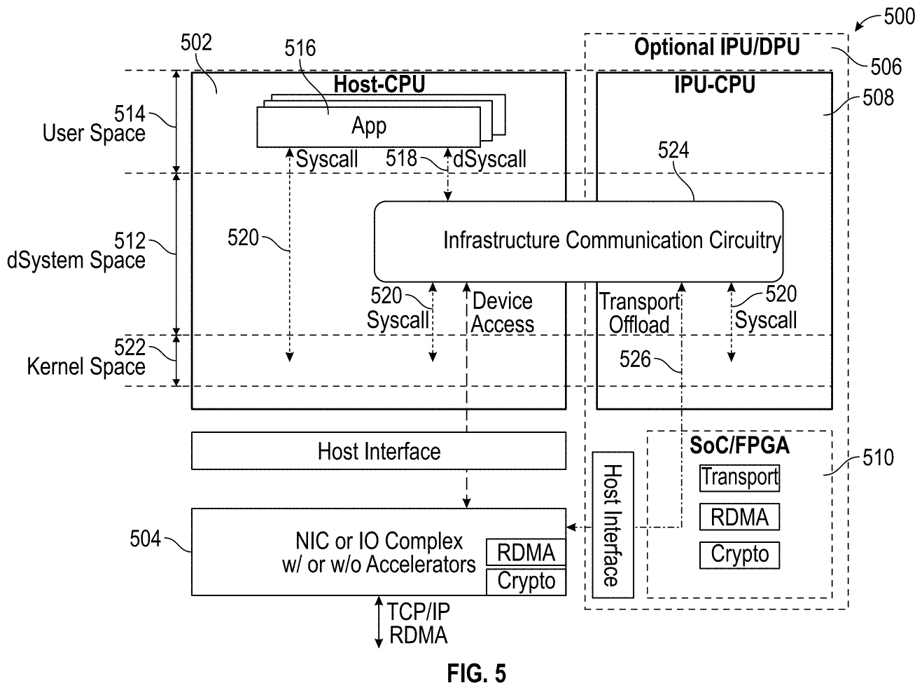

FIG. 5 illustrates a processing apparatus 500 architecture in which some example embodiments can be implemented. A system according to architecture 500 can be built on a host 502, wherein the host can be comprised of available systems, e.g., an x86 host, with no or minimal additional enhancements or changes, The host 502 can control the I/O devices 504, which can include, for example, a network interface card (NIC) NIC or IO complex with or without accelerators. Accelerators and accelerator apparatuses here and elsewhere can include a communication interface coupled to the host 502 directly or indirectly. The accelerators can include circuitry (e.g., coprocessor circuitry) coupled to this interface to receive input data over a shared memory mechanism from the host, the input data including L4 payloads. The input data typically will not include ethernet header information and will include only payload data.

An IPU or DPU 506 can optionally be included in the system 500. and is optional. In examples, the IPU or DPU 506 can include processing circuitry (e.g., a central processing unit (CPU)) 508 for general computing and/or a system on chip (SoC) or field programmable gate array (FPGA) 510 for implementing, for example, data processing. By including an IPU/DPU 506, the overall system 500 can provide an enhanced data plane.

Architectures according to embodiments incorporate different functionalities of the host 502, IPU/DPU 506, etc. using software or other authored executable code to integrate different hardware elements of the system 500.

### dSystem Space

In some available service mesh scenarios, the application container and sidecar container can run on an operating system (OS). An application and sidecar can communicate in a peer-to-peer relationship (from the networking perspective), and network optimization is implemented to reduce communication latency. In contrast, in example embodiments, the relationship between the application and sidecar are redesigned to no longer consider the sidecar is as another entity similar to the user application. Instead, the dSystem space 512 has more privilege than the user space 514, but less privilege than the kernel space 522. The dSystem space 512 can be reserved for, e.g., a service mesh or microservice infrastructure. When a user application 516 initiates a request, the context can be switched from the user space 514 to the dSystem space 512 to serve the request.

The dSystem space 512 is a hardware assisted execution environment and can be implemented by either a reserved CPU ring (ring 1 or ring 2), or a system execution environment with a dSystem flag, similar to, for example a flag used to implement a hypervisor root mode for a hardware assisted virtualization environment.

The design of the dSystem space 512 has advantages over traditional sidecar implementation that result in an improvement in operation of a computer and an improvement in computer technology. For example, the dSystem space 512 reduces or eliminates the software stack path from the user applications 516 application to the sidecar and removes introduced network layer overhead. As a second example, the dSystem space 512 has more privilege relative to the user space 502, and therefore the dSystem space 512 can access any relevant application page table and read through the sidecar request buffer directly without an extra memory operation (e.g., memory copy). As a further advantage, because the dSystem space 512 has less privilege than the kernel space 522, and is not part of kernel, the implemented distributed system framework as described herein will not taint the kernel, and instead, is under the protection of the kernel space 522 without having any capability to crash the system 500.

### dSyscall

One or more system call/s specific to the dSystem space 512, which will be referred to hereinafter as dSyscall 518, can be considered gates or points of entry into the dSystem space 512. When a dSyscall 518 is invoked, the execution is provisioned into dSystem space 512. Other syscalls 520 can continue to be provided for entrance into kernel space 522. For example, syscalls 520 can be provide between user applications 516 and the kernel space 522. Syscalls 520 can be provided between infrastructure communication circuitry 524 and the kernel space 522.

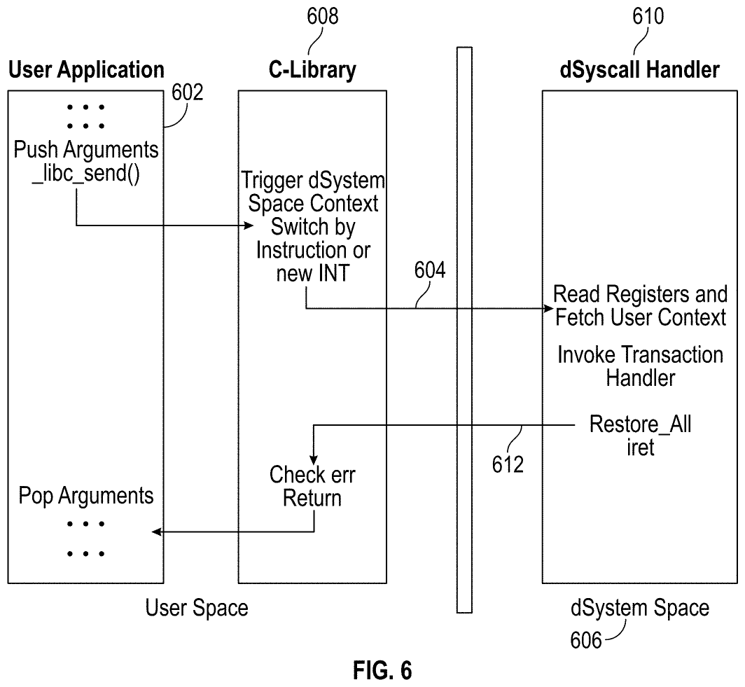

FIG. 6 illustrates dSyscall workflow in accordance with some embodiments. When a user application 602 initiates a request to service mesh, in contrast to a socket-based request in available systems, a dSyscall operation 604 can be performed in to execute a context switch to the dSystem space 606.

Library functions (e.g., C libraries although embodiments are not limited thereto) 608 can control entry into dSyscall handlers 610. Instead of user applications invoking a syscall (e.g., send( ) or other calls into a kernel)) systems according to aspects invoke a dSyscall, thereby reducing latency and other negative aspects described above. In example aspects, dSyscall implementation can include a new instruction, or a new interrupt (“INT”) number, for example 0x81 to Register EAX instead of 0x80 for syscall. As a result, a “dSyscall interrupt” can be triggered to transfer control to the dSystem space 606. In the dSystem space 606, a dSystem_call_table can route the call to a corresponding handler, which is implemented in the infrastructure communication circuitry introduced above with reference to FIG. 5. The dSyscall Handler 610 can read associated registers, and fetch user context including corresponding page tables, and subsequently invoke the corresponding transaction handler for further processing. Afterwards, the dSyscall returns at line 612 and the user application 602 will not be aware or otherwise affected by the call being provisioned to the dSystem space 606 instead of the kernel. Methods according to various embodiments, therefore, can reduce overhead relative to network-based solutions without requiring extensive user application changes or reprogramming.

Furthermore, when the infrastructure communication circuitry completes the above-described request, the infrastructure communication circuitry can directly write the buffers in the user application. Therefore, when the user application 602 returns from processing, a response has already been prepared without added networking transmission or memory copy.

### Infrastructure Communication Circuitry

Referring again to FIG. 5, the infrastructure communication circuitry 524 can be created and execute within the dSystem space 512. The infrastructure communication circuitry 524 can control traffic subsequent to user applications 516 triggering dSyscalls 518 and can fulfill service mesh control logic. After the service mesh functionalities are executed, the infrastructure communication circuitry 524 can control 10 devices 504 to transmit data over TCP/IP or RDMA.

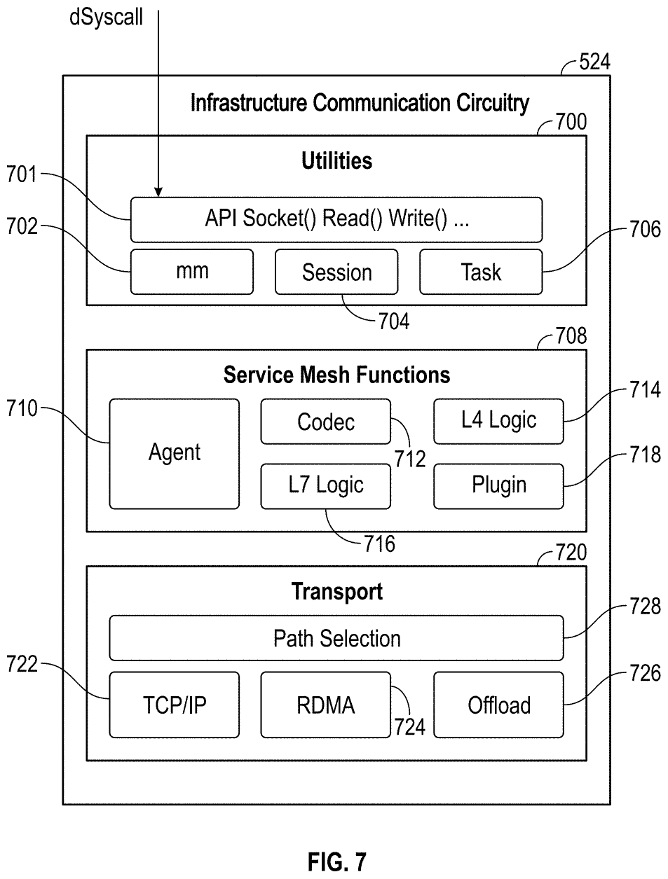

FIG. 7 illustrates infrastructure communication circuitry components according to some example embodiments. The infrastructure communication circuitry 524 can include at least three types of functionalities. A first type of functionality can include utilities 700. Utilities 700 can provide the APIs 701 of the dSyscalls, and implement memory management 702, session management 704, and task management 706.

Service mesh functions 708 perform features of a service mesh. For example, an agent 710 can communicate to a service mesh controller to gather information regarding mesh topology and service configurations, and report metrics to the service mesh controller. Codec 712 can decode and encode headers and payloads (e.g., HTTP headers although embodiments are not limited thereto) and transfer packets.

L4 logic 714 and L7 logic 716 can provide a platform layer and infrastructure layer functionality to enable managed, observable secure communication. For example, L4 logic 714 and L7 logic 716 can receive configurations from the agent 710 and from agent, execute the controlling to the controlling operations of the service mesh traffic. A plugin 718 can be written by an application developer or other customer, although embodiments are not limited thereto. The plugin 718 can comprise a flexible framework to support users in customization of usage of the infrastructure communication circuitry 524.

Transport 720 can include an adaptive layer that enables the infrastructure communication circuitry 524 to integrate with different I/O devices. For example, the transport 720 can contain a dSystem space networking TCP/IP stack 722 and an RDMA stack 724 to support data transfer. Embodiments can further include a hardware offloading transport 726 to hand over an L4 networking workload to IPU/DPU, which is can in turn improve the data transferring performance. To deal with different transport entities, embodiments define a path selection component 728 to choose the best data path dynamically according to service mesh deployment.

### Hardware Offloading Transport

Referring again to FIG. 5, if the system 500 includes the optional IPU/DPU 506, the infrastructure communication circuitry 524 can offload L4 transport functionalities at 526 to the SoC or FPGA 210 on the IPU/DPU 506, to enable a hardware ensured, more efficient data transmission.

In a typical service mesh, when the sidecar/proxy needs to transmit the requests or responses, the corresponding sidecar or proxy must perform this operation through the kernel's network stack. In contrast, in embodiments, rather than the host being responsible for this communication, communication is offloaded to an IPU/DPU 506 dedicated data processing hardware. There is no kernel network stack included in the transmission. Instead, the deliveries are all L4 payloads and transferred through a hardware assisted shared memory mechanism.

To implement this, embodiments provide the IPU with full L4 functionalities and corresponding software is implemented in the IPU/DPU 506.

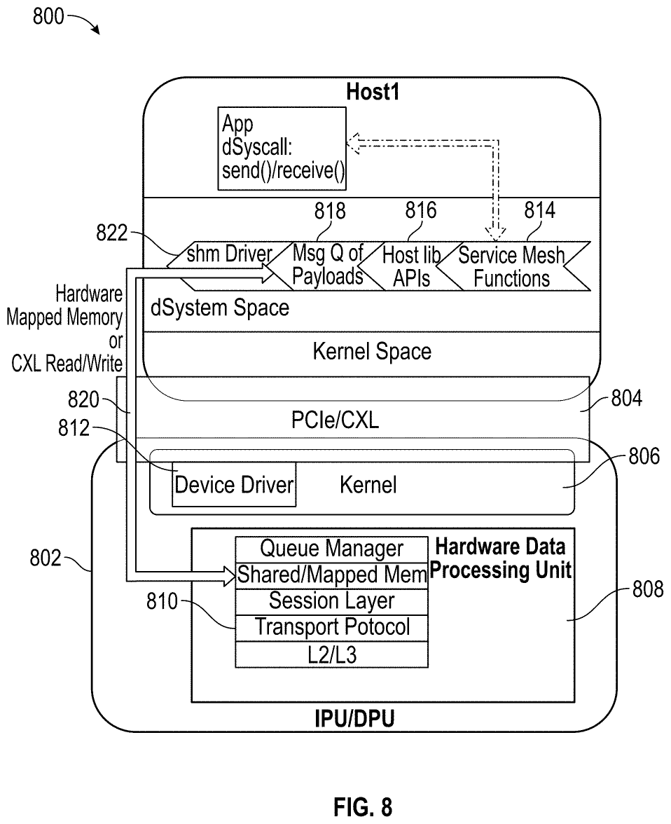

FIG. 8 illustrates components of an offloaded transport and host library according to some embodiments. A host 800 host and IPU or DPU 802 can be physically connected by a link 804, e.g., PCIe link, using for example PCIe protocol or compute express link (CXL). The IPU or DPU 802 can offload L4 functionalities from a kernel 806 network stack, and embodiments provide a mechanism for infrastructure communication circuitry running on the host 800 to extend itself to this offloaded transport.

The IPU/DPU 802 includes a hardware data processing unit 808, which can comprise a dedicated chip connected to the PCIe links 804 and NICs on the board. The hardware data processing unit 808 can include a SoC or a FPGA and can be designed for high performance networking processing. As depicted in block 810, the hardware data processing unit 808 can handle networking protocols up to layer 4 and can include session and memory-queue management. The hardware data processing unit 808 can have the responsibility of handling all the L4 transferring jobs.

CPUs on the host 800 and the and hardware data processing unit 808 on IPU 802 can access each other's memory space by driving PCIe DMA or CXL read/write commands at link 804. A device driver 812 can assist the hardware data processing unit 808 in exposing configuration and memory space to the host 800 as, e.g., a plurality of PCIe devices.

At block 814, when the application sends a packet to infrastructure communication circuitry by invoking dSyscalls, service mesh functions are executed without handling the TCP/IP, the request/response sent from/to the client, or the L4 payload send from or to the client will be passed down to IPU by invoking host library APIs.

At block 816, host library APIs can provide a set of interfaces to interact with the hardware data processing unit 808 on IPU/DPU 802 via a dedicated control path to create/destroy a session, negotiate shared memory usage and provide control to the data path. The APIs can support both synchronous and asynchronous transmission modes.

At block 818, a message queue for payloads can include a first in first out (FIFO) queue to cache all or a plurality of messages from block 816. In some examples, the item of the queue can be mapped to an IPU 802 memory space as shown in connection 820 by a shared memory driver 822. Once the packets are written into this queue, packets are in the corresponding queue on the IPU 802, due to these shared memory operations.

Shared memory driver 822 can emulate the hardware data processing unit 808 devices on PCIe links, create the configuration channel for host library APIs, and create the memory mapping for the message queue block 818. If the underlayer is PCIe, the memory map can be implemented by DMA operations. If the underlayer is CXL, there memory map can be implemented by CXL read/write. Elements 816, 818 and 820 can be considered equivalent to block 726 (FIG. 7).

### Path Selection

While embodiments above relate to an offloaded transport using an IPU/DPU, data paths without IPU/DPU are also supported in some example aspects.

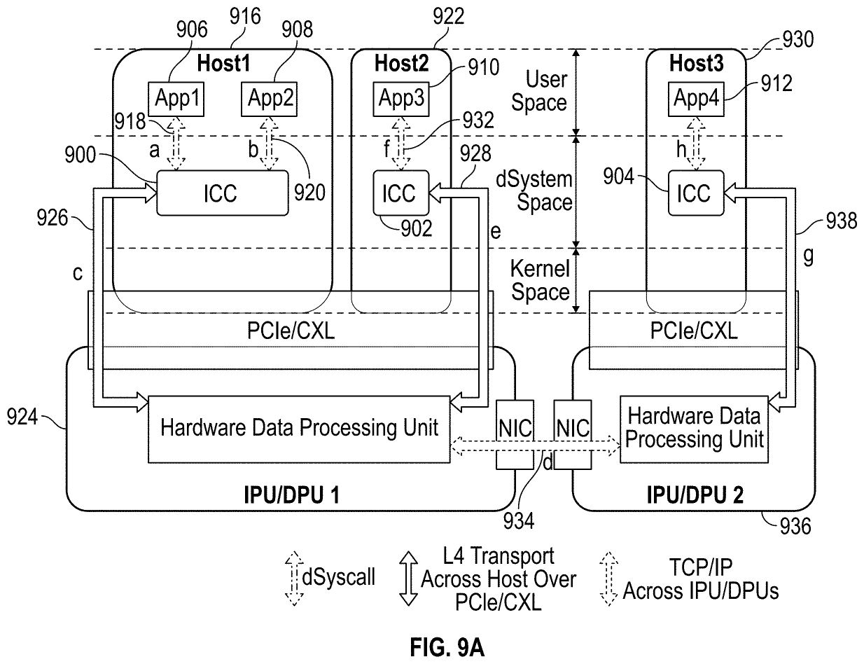

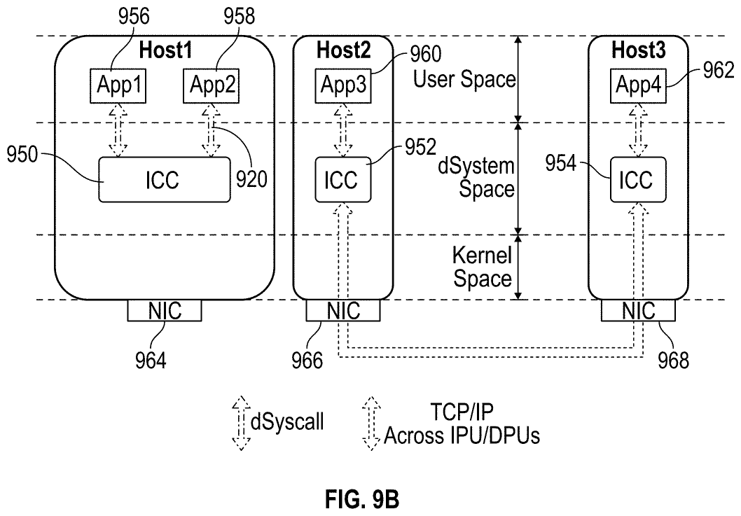

FIG. 9A illustrates an overview of different data paths organized into a flexible system having IPU/DPU elements according to example embodiments. FIG. 9B illustrates an overview of different data paths organized into a flexible system having IPU/DPU elements according to example embodiments. Circuitry 900, 902, 904 and 950, 952, 954 represent infrastructure communication circuitry as described earlier herein. In both FIG. 9A and 9B the service mesh control plane is enhanced such that, whenever an application 906, 908, 910, 912, 956, 958, 960, 962 initiates or is an originating application for a connection to a remote service endpoint, the service mesh software obtains the routing and destination and determines the best path to take. The control plane, which can be incorporated in controller circuitry (not shown in FIG. 9A and 9B) can collect the service mesh cluster information and status changing to dynamically update the best path.

In one example, referring to FIG. 9A, if application 906 accesses application 908, since both are in a same host 916, both are covered by a same DSF 900, so the best path is from application 906 to DSF 900 using dSyscall 918 and from there to application 908 using dSyscall 920.

In a second example, if application 906 wishes to access application 910, these are in different hosts 916, 922 but share the same IPU/DPU 924. The transport can be offloaded by IPU/DPU 924. The best data path can be from application 906 to dSyscall 918, to DSF 900 to L4 transport 926 across a host over PCI/CXL, across a second L4 transport 928 to DSF 902 to application 910.

In a third example, if application 910 wishes to access application 912, this is on a different host 930 that does not share the same IPU/DPU 924. The best data path could be: application 910 over dSyscall 932 to DSF 902, and from there over L4 transport 928 to IPU/DPU 924. Next, using TCP/IP link 934 to IPU/DPU 936, then over L4 transport 938 to DSF 904 to application 912.

FIG. 9B illustrates a similar setup except rather than IPU/DPU components, communication is over, for example, NIC 964, 966, 968. L4 transports are not provided in the embodiment illustrated in FIG. 9B.

FIGS. 10A and 10B provide an overview of example components within a computing device in an edge computing system 1000, according to an embodiment. Edge computing system 1000 may be used to provide infrastructure communication circuitry such as those shown in FIG. 5 and any other components or circuitry described above. In further examples, any of the compute nodes or devices discussed with reference to the present edge computing systems and environment may be fulfilled based on the components depicted in FIGS. 10A and 10B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 10A, an edge compute node 1000 includes a compute engine (also referred to herein as “compute circuitry”) 1002, an input/output (I/O) subsystem 1008 (also referred to herein as “I/O circuitry”), data storage 1010 (also referred to herein as “data storage circuitry”), a communication circuitry subsystem 1012, and, optionally, one or more peripheral devices 1014 (also referred to herein as “peripheral device circuitry”). In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 1000 may be embodied as any type of engine, device, or collection of devices capable of performing various compute functions. In some examples, the compute node 1000 may be embodied as a single device such as an integrated circuit, an embedded system, a field-programmable gate array (FPGA), a system-on-a-chip (SOC), or other integrated system or device. In the illustrative example, the compute node 1000 includes or is embodied as a processor 1004 (also referred to herein as “processor circuitry”) and a memory 1006 (also referred to herein as “memory circuitry”). The processor 1004 may be embodied as any type of processor capable of performing the functions described herein (e.g., executing an application). For example, the processor 1004 may be embodied as a multi-core processor(s), a microcontroller, a processing unit, a specialized or special purpose processing unit, or other processor or processing/controlling circuit.

In some examples, the processor 1004 may be embodied as, include, or be coupled to an FPGA, an application specific integrated circuit (ASIC), reconfigurable hardware or hardware circuitry, or other specialized hardware to facilitate performance of the functions described herein. In some examples, the processor 1004 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, storage disks, or AI hardware (e.g., GPUs, programmed FPGAs, or ASICs tailored to implement an AI model such as a neural network). Such an xPU may be designed to receive, retrieve, and/or otherwise obtain programming to process one or more data streams and perform specific tasks and actions for the data streams (such as hosting microservices, performing service management or orchestration, organizing or managing server or data center hardware, managing service meshes, or collecting and distributing telemetry), outside of the CPU or general-purpose processing hardware. However, it will be understood that a xPU, a SOC, a CPU, and other variations of the processor 1004 may work in coordination with each other to execute many types of operations and instructions within and on behalf of the compute node 1000.

The memory 1006 may be embodied as any type of volatile (e.g., dynamic random-access memory (DRAM), etc.) or non-volatile memory or data storage capable of performing the functions described herein. The compute circuitry 1002 is communicatively coupled to other components of the compute node 1000 via the I/O subsystem 1008, which may be embodied as circuitry and/or components to facilitate input/output operations with the compute circuitry 1002 (e.g., with the processor 1004 and/or the main memory 1006) and other components of the compute circuitry 1002. For example, the I/O subsystem 1008 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1008 may form a portion of a system-on-a-chip (SoC) and be incorporated, along with one or more of the processor 1004, the memory 1006, and other components of the compute circuitry 1002, into the compute circuitry 1002.

The one or more illustrative data storage devices/disks 1010 may be embodied as one or more of any type(s) of physical device(s) configured for short-term or long-term storage of data such as, for example, memory devices, memory, circuitry, memory cards, flash memory, hard disk drives, solid-state drives (SSDs), and/or other data storage devices/disks. Individual data storage devices/disks 1010 may include a system partition that stores data and firmware code for the data storage device/disk 1010. Individual data storage devices/disks 1010 may also include one or more operating system partitions that store data files and executables for operating systems depending on, for example, the type of compute node 1000.

The communication circuitry 1012 may be embodied as any communication circuit, device, or collection thereof, capable of enabling communications over a network between the compute circuitry 1002 and another compute device (e.g., an edge gateway of an implementing edge computing system). The communication circuitry 1002 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 1012 includes a network interface controller (NIC) 1020, which may also be referred to as a host fabric interface (HFI). The NIC 1020 may be embodied as one or more add-in-boards, daughter cards, network interface cards, controller chips, chipsets, or other devices that may be used by the compute node 1000 to connect with another compute device (e.g., an edge gateway node). In some examples, the NIC 1020 may be embodied as part of a system-on-a-chip (SoC) that includes one or more processors or included on a multichip package that also contains one or more processors. In some examples, the NIC 1020 may include a local processor (not shown) and/or a local memory (not shown) that are both local to the NIC 1020. In such examples, the local processor of the NIC 1020 may be capable of performing one or more of the functions of the compute circuitry 1002 described herein. Additionally, or alternatively, in such examples, the local memory of the NIC 1020 may be integrated into one or more components of the client compute node at the board level, socket level, chip level, and/or other levels. Additionally, in some examples, a respective compute node 1000 may include one or more peripheral devices 1014.

In a more detailed example, FIG. 10B illustrates a block diagram of an example of components that may be present in an edge computing node 1050 for implementing the techniques (e.g., operations, processes, methods, and methodologies) described herein. This edge computing node 1050 provides a closer view of the respective components of node 1000 when implemented as or as part of a computing device (e.g., as a mobile device, a base station, server, gateway, etc.). The edge computing node 1050 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 1050, or as components otherwise incorporated within a chassis of a larger system.

The edge computing device 1050 may include processing circuitry in the form of a processor 1052, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 1052 may be a part of a system on a chip (SoC) in which the processor 1052 and other components are formed into a single integrated circuit, or a single package, such as the Edison™ or Galileo™ SoC boards from Intel Corporation, Santa Clara, Calif. As an example, the processor 1052 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 1052 and accompanying circuitry may be provided in a single socket form factor, multiple socket form factor, or a variety of other formats, including in limited hardware configurations or configurations that include fewer than all elements shown in FIG. 11B.

The processor 1052 may communicate with a system memory 1054 over an interconnect 1056 (e.g., a bus). Any number of memory devices may be used to provide for a given amount of system memory. To provide for persistent storage of information such as data, applications, operating systems and so forth, a storage 1058 may also couple to the processor 1052 via the interconnect 1056.

The components may communicate over the interconnect 1056. The interconnect 1056 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1056 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 1056 may couple the processor 1052 to a transceiver 1066, for communications with the connected edge devices 1062. The wireless network transceiver 1066 (or multiple transceivers) may communicate using multiple standards or radios for communications at a different range. For example, the edge computing node 1050 may communicate with close devices, e.g., within about 10 meters, using a local transceiver based on Bluetooth Low Energy (BLE), or another low power radio, to save power. More distant connected edge devices 1062, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 1066 (e.g., a radio transceiver) may be included to communicate with devices or services in a cloud (e.g., an edge cloud 1095) via local or wide area network protocols.

Any number of other radio communications and protocols may be used in addition to the systems mentioned for the wireless network transceiver 1066. A network interface controller (NIC) 1068 may be included to provide a wired communication to nodes of the edge cloud 1095 or to other devices, such as the connected edge devices 1062 (e.g., operating in a mesh).

The edge computing node 1050 may include or be coupled to acceleration circuitry 1064, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 1056 may couple the processor 1052 to a sensor hub or external interface 1070 that is used to connect additional devices or subsystems. The devices may include sensors 1072, such as accelerometers, level sensors, flow sensors, optical light sensors, camera sensors, temperature sensors, global navigation system (e.g., GPS) sensors, pressure sensors, barometric pressure sensors, and the like. The hub or interface 1070 further may be used to connect the edge computing node 1050 to actuators 1074, such as power switches, valve actuators, an audible sound generator, a visual warning device, and the like.

In some optional examples, various input/output (I/O) devices may be present within or connected to, the edge computing node 1050. For example, a display or other output device 1084 may be included to show information, such as sensor readings or actuator position. An input device 1086, such as a touch screen or keypad may be included to accept input. An output device 1084 may include any number of forms of audio or visual display.

A battery 1076 may power the edge computing node 1050, although, in examples in which the edge computing node 1050 is mounted in a fixed location, it may have a power supply coupled to an electrical grid, or the battery may be used as a backup or for temporary capabilities. The battery 1076 may be a lithium-ion battery, or a metal-air battery, such as a zinc-air battery, an aluminum-air battery, a lithium-air battery, and the like. A battery monitor/charger 1078 may be included in the edge computing node 1050 to track the state of charge (SoCh) of the battery 1076, if included. A power block 1080, or other power supply coupled to a grid, may be coupled with the battery monitor/charger 1078 to charge the battery 1076.

The storage 1058 may include instructions 1082 in the form of software, firmware, or hardware commands to implement the techniques described herein. Although such instructions 1082 are shown as code blocks included in the memory 1054 and the storage 1058, it may be understood that any of the code blocks may be replaced with hardwired circuits, for example, built into an application specific integrated circuit (ASIC).

In an example, the instructions 1082 provided via the memory 1054, the storage 1058, or the processor 1052 may be embodied as a non-transitory, machine-readable medium 1060 including code to direct the processor 1052 to perform electronic operations in the edge computing node 1050. The processor 1052 may access the non-transitory, machine-readable medium 1060 over the interconnect 1056. For instance, the non-transitory, machine-readable medium 1060 may be embodied by devices described for the storage 1058 or may include specific storage units such as storage devices and/or storage disks that include optical disks (e.g., digital versatile disk (DVD), compact disk (CD), CD-ROM, Blu-ray disk), flash drives, floppy disks, hard drives (e.g., SSDs), or any number of other hardware devices in which information is stored for any duration (e.g., for extended time periods, permanently, for brief instances, for temporarily buffering, and/or caching). The non-transitory, machine-readable medium 1060 may include instructions to direct the processor 1052 to perform a specific sequence or flow of actions, for example, as described with respect to the flowchart(s) and block diagram(s) of operations and functionality depicted above. As used herein, the terms “machine-readable medium” and “computer-readable medium” are interchangeable. As used herein, the term “non-transitory computer-readable medium” is expressly defined to include any type of computer readable storage device and/or storage disk and to exclude propagating signals and to exclude transmission media.

Also in a specific example, the instructions 1082 on the processor 1052 (separately, or in combination with the instructions 1082 of the machine readable medium 1060) may configure execution or operation of a trusted execution environment (TEE) 1090. In an example, the TEE 1090 operates as a protected area accessible to the processor 1052 for secure execution of instructions and secure access to data. Various implementations of the TEE 1090, and an accompanying secure area in the processor 1052 or the memory 1054 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1050 through the TEE 1090 and the processor 1052.

Example 1 is a processing apparatus comprising: a memory device including a user space for executing user applications; and infrastructure communication circuitry configured to receive a request from a user application executing in the user space; and responsive to receiving the request, perform service mesh operations and control network traffic corresponding to the re perform a service mesh operation, in response to the request, without a sidecar proxy quest.

In Example 2, the subject matter of Example 1 can optionally include wherein the system space operations are executed in ring 1 or ring 2 of a four-ring protection architecture.

In Example 3, the subject matter of any of Examples 1-2 can optionally include wherein the infrastructure communication circuitry is configured to transmit data in a hardware-assisted shared memory mechanism between the user space and the kernel space.

In Example 4, the subject matter of any of Examples 1-3 can optionally include an infrastructure processing unit (IPU) or data processing unit (DPU) configured to encapsulate user space application data for transmission in L4 payloads.

In Example 5, the subject matter of Example 4 can optionally include wherein transmission is performed over PCIe circuitry.

In Example 6, the subject matter of Example 4 can optionally include wherein the IPU/DPU couples two host devices.

In Example 7, the subject matter of Example 6 can optionally include wherein applications executing on each of the two host devices communicate through the IPU/DPU.

In Example 8, the subject matter of Example 4 can optionally include wherein the IPU/DPU includes a hardware data processing circuitry for network communication with a host system.

In Example 9, the subject matter of Example 8 can optionally include wherein the hardware data processing circuitry comprises a system on chip (SoC).

In Example 10, the subject matter of Example 8 can optionally include wherein the hardware data processing circuitry comprises a field programmable gate array (FPGA).

In Example 11, the subject matter of any of Examples 1-10 can optionally include wherein the request to perform the process comprises a trigger to trigger a context switch to the system space.

In Example 12, the subject matter of any of Examples 1-11 can optionally include a network interface circuitry coupled between at least two host devices executing at least two user applications.

Example 13 can include a method comprising: triggering, by an originating application included in a user space of an apparatus, a context switch to switch context to a distributed system space having a higher privilege level than the user space and a lower privilege level than a kernel space of the apparatus; and responsive to the context switch, perform service mesh operations and control network traffic corresponding to the context switch, the distributed system space having higher privilege level than the system user space, the distributed system space having a lower privilege level than a kernel system space.

In Example 14, the subject matter of Example 13 can optionally include wherein the service mesh operations are executed by invoking an application programming interface to negotiate shared memory usage with a second apparatus.

In Example 15, the subject matter of any of Examples 13-14 can optionally include wherein the context switch includes a request to access a second application, the second application on a same host as the originating application.

In Example 16, the subject matter of any of Examples 13-15 can optionally include wherein the context switch includes a request to access a second application on a different host than the originating application.

Example 17 is a system comprising: at least two host apparatuses including memory devices having virtual memory configured into a user space having a first privilege level and a kernel space having a second privilege level higher than the first privilege level; and infrastructure communication circuitry configured to execute within a system space of the memory device, the system space having a third privilege level higher than the first privilege level and lower than the second privilege level, the infrastructure communication circuitry configured to: receive, from the user space, a request to perform a process for a corresponding user application in the user space; and responsive to receiving the request, perform service mesh operations and control network traffic corresponding to the request.

In Example 18, the subject matter of Example 17 can optionally include wherein the system space operations are executed in ring 1 or ring 2 of a four-ring protection architecture.

In Example 19, the subject matter of any of Examples 17-18 can optionally include wherein the infrastructure communication circuitry is configured to transmit data in a hardware-assisted shared memory mechanism between the user space and the kernel space.

In Example 20, the subject matter of any of Examples 17-19 can optionally include at least one of an infrastructure processing unit (IPU) or data processing unit (DPU) configured to encapsulate user space application data for transmission in L4 payloads.

In Example 21, the subject matter of Example 20 can optionally include wherein the IPU/DPU couples two host apparatuses.

Example 22 is an accelerator apparatus comprising: a communication interface coupled to a host device; coprocessor circuitry coupled to the communication interface and configured to receive input data over a shared memory mechanism from the host, the input data including L4 payloads; and perform an accelerator function on the input data on behalf of the host.

In Example 23, the subject matter of Example 22 can optionally include wherein the input data does not include ethernet header information.

In Example 24, the subject matter of Example 23 can optionally include wherein the coprocessor circuitry is configured to add ethernet header information to the input data.

In Example 25, the subject matter of any of Examples 22-24 can optionally include wherein the accelerator apparatus is comprises a cryptographic accelerator.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A processing apparatus comprising:
a memory device including a user space for executing user applications; and
infrastructure communication circuitry configured to:
receive a request from a user application executing in the user space; and
perform a service mesh operation, in response to the request, without a sidecar proxy.

2. The processing apparatus of claim 1, wherein:
the user space has a first privilege level and wherein the memory device further includes a kernel space having a second privilege level higher than the first privilege level; and
the infrastructure communication circuitry is configured to:
execute within a system space of the memory device, the system space having a third privilege level higher than the first privilege level and lower than the second privilege level; and
responsive to receiving the request, control network traffic corresponding to the request.

3. The processing apparatus of claim 2, wherein operations of the system space are executed in ring 1 or ring 2 of a four-ring protection architecture.

4. The processing apparatus of claim 2, wherein the infrastructure communication circuitry is configured to transmit data in a hardware-assisted shared memory mechanism between the user space and the kernel space.

5. The processing apparatus of claim 1, further comprising an infrastructure processing unit (IPU) or data processing unit (DPU) configured to encapsulate user space application data for transmission in L4 payloads.

6. The processing apparatus of claim 5, wherein transmission is performed over PCIe circuitry.

7. The processing apparatus of claim 5, wherein the IPU/DPU couples two host devices.

8. The processing apparatus of claim 7, wherein applications executing on each of the two host devices communicate through the IPU/DPU.

9. The processing apparatus of claim 5, wherein the IPU/DPU includes a hardware data processing circuitry for network communication with a host system.

10. The processing apparatus of claim 9, wherein the hardware data processing circuitry comprises a system on chip (SoC).

11. The processing apparatus of claim 9, wherein the hardware data processing circuitry comprises a field programmable gate array (FPGA).

12. The processing apparatus of claim 2, wherein the request to perform the process comprises a trigger to trigger a context switch to the system space.

13. The processing apparatus of claim 2, further comprising a network interface circuitry coupled between at least two host devices executing at least two user applications.

14. A method comprising:
triggering, by an originating application included in a user space of an apparatus, a context switch to switch context to a distributed system space having a higher privilege level than the user space and a lower privilege level than a kernel space of the apparatus; and
responsive to the context switch, perform service mesh operations and control network traffic corresponding to the context switch, the distributed system space having higher privilege level than the system user space, the distributed system space having a lower privilege level than a kernel system space.

15. The method of claim 14, wherein the service mesh operations are executed by invoking an application programming interface to negotiate shared memory usage with a second apparatus.

16. The method of claim 14, wherein the context switch includes a request to access a second application, the second application on a same host as the originating application.

17. The method of claim 14, wherein the context switch includes a request to access a second application on a different host than the originating application.

18. A system comprising:
at least two host apparatuses including memory devices having virtual memory configured into a user space having a first privilege level and a kernel space having a second privilege level higher than the first privilege level; and
infrastructure communication circuitry configured to execute within a system space of the memory device, the system space having a third privilege level higher than the first privilege level and lower than the second privilege level, the infrastructure communication circuitry configured to:
receive, from the user space, a request to perform a process for a corresponding user application in the user space; and
responsive to receiving the request, perform service mesh operations and control network traffic corresponding to the request.

19. The system of claim 18, wherein the system space operations are executed in ring 1 or ring 2 of a four-ring protection architecture.

20. The system of claim 18, wherein the infrastructure communication circuitry is configured to transmit data in a hardware-assisted shared memory mechanism between the user space and the kernel space.

21. The system of claim 18, further comprising at least one of an infrastructure processing unit (IPU) or data processing unit (DPU) configured to encapsulate user space application data for transmission in L4 payloads.

22. The system of claim 21, wherein the IPU/DPU couples two host apparatuses.

23. An accelerator apparatus comprising:
a communication interface coupled to a host device;
coprocessor circuitry coupled to the communication interface and configured to receive input data over a shared memory mechanism from the host, the input data including L4 payloads; and
perform an accelerator function on the input data on behalf of the host.

24. The accelerator apparatus of claim 23, wherein the input data does not include ethernet header information.

25. The accelerator apparatus of claim 24, wherein the coprocessor circuitry is configured to add ethernet header information to the input data.
